(19) United States
(12) Patent Application Publication
(10) Pub. No.: US 2009/0007791 A1
(43) Pub. Date: Jan. 8, 2009

(54) Cup Having Floatable Strainer

(76) Inventor: Hsing-Hui Chen, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/772,580

(22) Filed: Jul. 2, 2007

(51) Int. Cl. A47J 31/18; A47J 31/20

(52) U.S. Cl. 99/279

(57) ABSTRACT

A cup includes a hollow cup body, a floatable strainer floatably mounted in the cup body, and a movable handle movably mounted on the cup body. Thus, the floatable strainer is lifted in the cup body slowly and gradually during the tea brewing process so that the tea bag is spaced from the hot water during a determined period of time so as to prevent the tea bag from being soaked in the hot water too long and to prevent the tea contained in the receiving chamber of the cup body from being too dense so that the tea density in the receiving chamber of the cup body is kept at the optimum state.

### BACKGROUND OF THE INVENTION

1. Field of the Invention

The present invention relates to a cup and, more particularly, to a tea cup for brewing tea.

2. Description of the Related Art

A conventional cup in accordance with the prior art shown in FIG. 4 comprises a hollow cup body 10 having an inside formed with a receiving chamber 12, and a strainer 11 mounted in the receiving chamber 12 of the cup body 11 and having a top formed with a protruding flange 111 rested on the top of the cup body 11 and a periphery formed with a plurality of through holes 112 connected to the receiving chamber 12 of the cup body 1 1. In brewing tea, a tea bag (not shown) is initially received in the strainer 11. Then, hot water is poured into the strainer 11 and through the through holes 112 of the strainer 11 into the receiving chamber 12 of the cup body 11 until the hot water is filled with the strainer 11 and the receiving chamber 12 of the cup body 11. Thus, the tea bag is soaked in the hot water to brew the tea bag so that the tea particles contained in the tea bag are mixed with the hot water to form a liquid mixture of tea for use with a user. However, the tea bag is soaked in the hot water constantly so that the tea contained in the receiving chamber 12 of the cup body 11 is too dense during a longer period of time, thereby easily producing a bitter sensation to the drinker.

### BRIEF SUMMARY OF THE INVENTION

In accordance with the present invention, there is provided a cup, comprising a hollow cup body, a floatable strainer floatably mounted in the cup body, and a movable handle movably mounted on the cup body.

The primary objective of the present invention is to provide a cup having a floatable strainer that is lifted automatically during a tea brewing process.

Another objective of the present invention is to provide a cup, wherein the floatable strainer is lifted in the cup body slowly and gradually during the tea brewing process so that the tea bag is spaced from the hot water during a determined period of time to prevent the tea bag from being soaked in the hot water too long and to prevent the tea contained in the receiving chamber of the cup body from being too dense so that the tea density in the receiving chamber of the cup body is kept at the optimum state.

A further objective of the present invention is to provide a cup, wherein the liquid mixture of the tea flows through the narrow gap slowly to slow down the lifting speed of the floatable strainer so that the tea bag received in the receiving space of the strainer body is soaked in the hot water during a determined period of time without affecting the density of the tea.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front exploded cross-sectional view of a cup in accordance with the preferred embodiment of the present invention.

FIG. 2 is a cross-sectional assembly view of the cup as shown in FIG. 1.

FIG. 3 is a front cross-sectional assembly view of a cup in accordance with another preferred embodiment of the present invention.

FIG. 4 is a front cross-sectional assembly view of a conventional cup in accordance with the prior art.

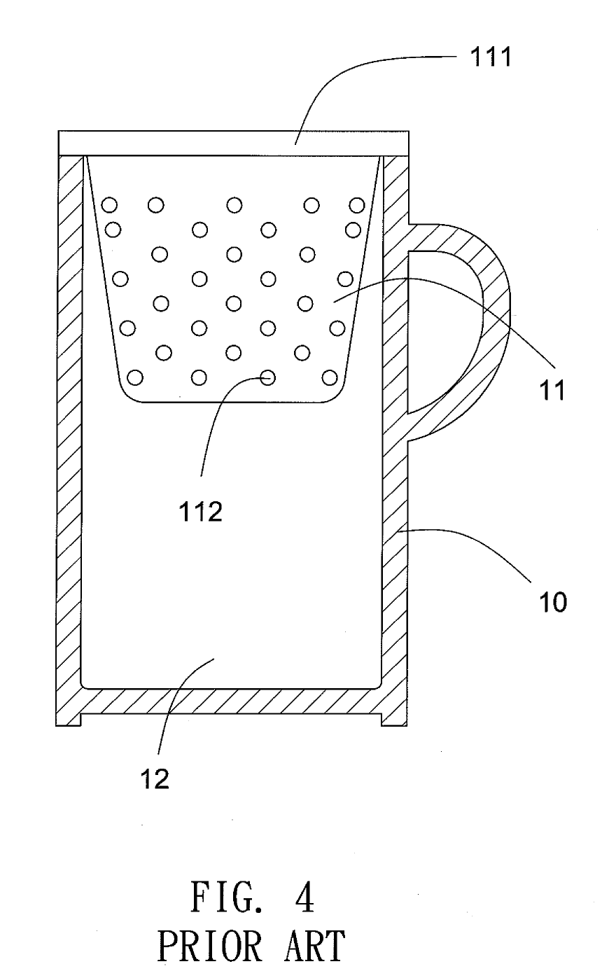

### DETAILED DESCRIPTION OF THE INVENTION

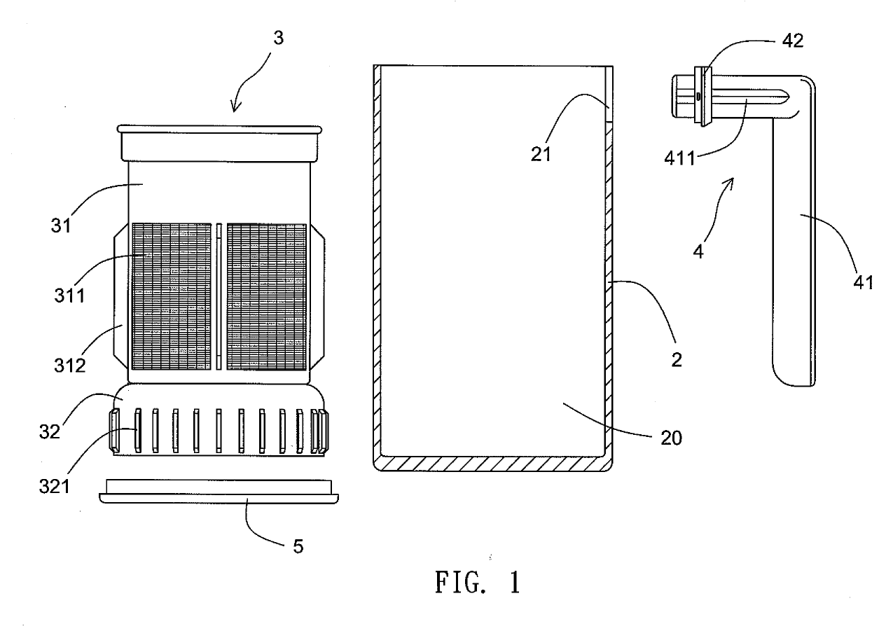

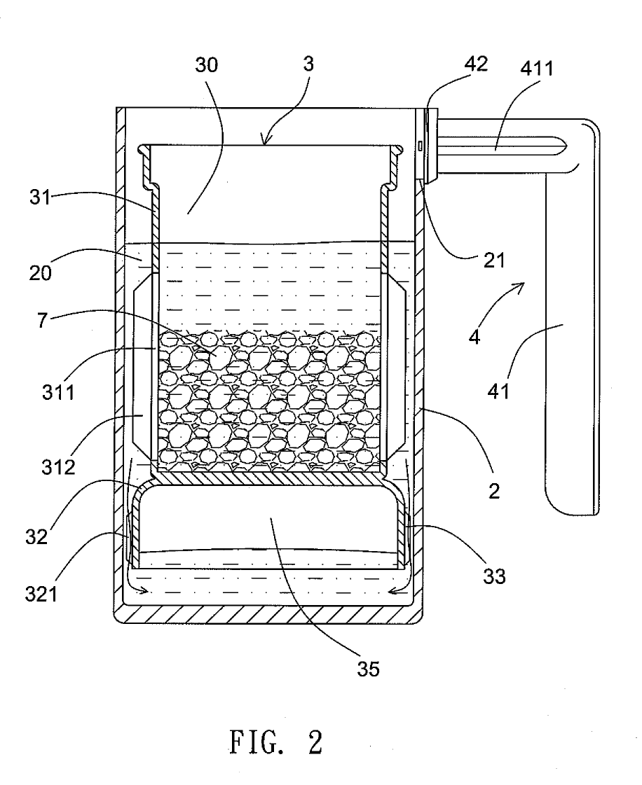

Referring to the drawings and initially to FIGS. 1 and 2, a cup for brewing tea in accordance with the preferred embodiment of the present invention comprises a hollow cup body 2, a floatable strainer 3 floatably mounted in the cup body 2, a movable handle 4 movably mounted on the cup body 2, and a lid 5 removably mounted on the cup body 2 or the floatable strainer 3.

The cup body 2 has a cylindrical shape and has an inside formed with a receiving chamber 20 to receive the floatable strainer 3. The cup body 2 has an open upper end formed with a recessed mounting seat 21.

The floatable strainer 3 has a height smaller than that of the mounting seat 21 of the cup body 2. The floatable strainer 3 includes a hollow strainer body 31 having an inside formed with a receiving space 30, a hollow floatable member 32 mounted on a lower end of the strainer body 31, and a filter 311 mounted on a periphery of the strainer body 31 and connected between the receiving chamber 20 of the cup body 2 and the receiving space 30 of the strainer body 31. The strainer body 31 of the floatable strainer 3 is spaced from an inner wall of the cup body 2 and has an outer wall formed with a plurality of outwardly protruding stabilizing ribs 312 that are movable to rest on the inner wall of the cup body 2 to enhance the stability of the strainer body 31 of the floatable strainer 3 in the cup body 2. The floatable member 32 of the floatable strainer 3 has a size greater than that of the strainer body 31. The floatable member 32 of the floatable strainer 3 is spaced from the inner wall of the cup body 2 to define a narrow gap 33 between the floatable member 32 of the floatable strainer 3 and the inner wall of the cup body 2. The floatable member 32 of the floatable strainer 3 has a periphery formed with a plurality of protruding spacers 321 which are equally spaced from each other to separate the narrow gap 33 from the floatable member 32 equally. The floatable member 32 of the floatable strainer 3 is received in a lower portion of the receiving chamber 20 of the cup body 2 and has an inside formed with an air chamber 35 that is connected to an upper portion of the receiving chamber 20 of the cup body 2 and the filter 311 of the strainer body 31 through the narrow gap 33. The air chamber 35 of the floatable member 32 is open in a direction opposite to that of the receiving chamber 20 of the cup body 2 and the receiving space 30 of the strainer body 31.

The movable handle 4 includes a fixing member 42 secured on the mounting seat 21 of the cup body 2 and a handle body 41 movably mounted on the fixing member 42 and movable into the receiving chamber 20 of the cup body 2. The handle body 41 of the movable handle 4 has a substantially inverted L-shaped profile and has an upper portion provided with a horizontal slide 411 slidably mounted on the fixing member 42 to guide movement of the handle body 41 relative to the fixing member 42.

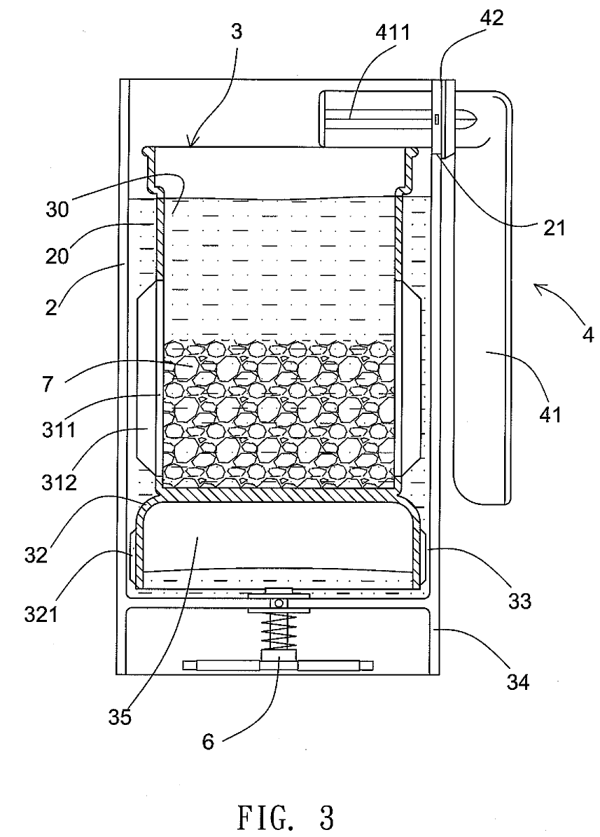

Thus, the handle body 41 of the movable handle 4 is movable toward the cup body 2 to extend the slide 411 into the receiving chamber 20 of the cup body 2 to rest on an end of the floatable strainer 3 to stop movement of the floatable strainer 3 as shown in FIG. 3. Alternatively, the handle body 41 of the movable handle 4 is movable outwardly relative to the cup body 2 to space the slide 411 from the cup body 2 so that a user's hand can hold the handle body 41 of the movable handle 4 as shown in FIG. 2.

In operation, a tea bag 7 is initially received in the receiving space 30 of the strainer body 3 1. Then, hot water is poured into the receiving space 30 of the strainer body 31 to soak the tea bag 7 in the hot water so as to brew the tea bag 7 so that the tea particles contained in the tea bag 7 are mixed with the hot water to form a liquid mixture. Then, the liquid mixture in the receiving space 30 of the strainer body 31 slowly flows through the filter 311 of the strainer body 31 into the receiving chamber 20 of the cup body 2 and then flows through the narrow gap 33 into the air chamber 35 of the floatable member 32 to encompass air contained in the air chamber 35 of the floatable member 32.

At this time, the air contained in the air chamber 35 of the floatable member 32 is isolated and compressed by the liquid mixture to produce a buoyancy to lift the floatable member 32 of the floatable strainer 3 so that the floatable strainer 3 is lifted in the cup body 2. In such a manner, the liquid mixture flows outwardly from the receiving space 30 of the strainer body 31 successively, and the floatable strainer 3 is lifted in the cup body 2 slowly and gradually during a determined period of time to expose the tea bag 7 outwardly from the water level the receiving chamber 20 of the cup body 2 to prevent the tea bag 7 from being soaked in the hot water during an excessive period of time and to prevent the tea contained in the receiving chamber 20 of the cup body 2 from being too dense so that the tea density in the receiving chamber 20 of the cup body 2 is kept at the optimum state. It is appreciated that, the liquid mixture flows through the narrow gap 33 slowly to slow down the lifting speed of the floatable strainer 3 so that the tea bag 7 received in the receiving space 30 of the strainer body 31 is soaked in the hot water during a determined period of time to produce the liquid mixture with a determined density.

Referring to FIG. 3, the cup further comprises a movable control valve 6 mounted on a bottom of the cup body 2 and connected to the receiving chamber 20 of the cup body 2 and the air chamber 35 of the floatable member 32 to introduce the liquid mixture outwardly from the receiving chamber 20 of the cup body 2 by pressing the control valve 6 for use with a user. The bottom of the cup body 2 has a peripheral wall formed with an annular skirt 34 extending downward to encompass the control valve 6 which is fully hidden in the skirt 34.

Accordingly, the floatable strainer 3 is lifted in the cup body 2 slowly and gradually during the tea brewing process so that the tea bag 7 is spaced from the hot water during a determined period of time to prevent the tea bag 7 from being soaked in the hot water too long and to prevent the tea contained in the receiving chamber 20 of the cup body 2 from being too dense so that the tea density in the receiving chamber 20 of the cup body 2 is kept at the optimum state. In addition, the liquid mixture of the tea flows through the narrow gap 33 slowly to slow down the lifting speed of the floatable strainer 3 so that the tea bag 7 received in the receiving space 30 of the strainer body 31 is soaked in the hot water during a determined period of time without affecting the density of the tea.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cup, comprising:
a hollow cup body;
a floatable strainer floatably mounted in the cup body;
a movable handle movably mounted on the cup body.

2. The cup in accordance with claim 1, wherein the cup body has an inside formed with a receiving chamber to receive the floatable strainer.

3. The cup in accordance with claim 2, wherein the floatable strainer includes:
a hollow strainer body having an inside formed with a receiving space;
a hollow floatable member mounted on a lower end of the strainer body.

4. The cup in accordance with claim 3, wherein the floatable strainer further includes a filter mounted on a periphery of the strainer body and connected between the receiving chamber of the cup body and the receiving space of the strainer body.

5. The cup in accordance with claim 3, wherein the strainer body of the floatable strainer is spaced from an inner wall of the cup body.

6. The cup in accordance with claim 3, wherein the strainer body of the floatable strainer has an outer wall formed with a plurality of outwardly protruding stabilizing ribs that are movable to rest on the inner wall of the cup body to enhance stability of the strainer body of the floatable strainer in the cup body.

7. The cup in accordance with claim 3, wherein the floatable member of the floatable strainer is spaced from an inner wall of the cup body to define a narrow gap between the floatable member of the floatable strainer and the inner wall of the cup body.

8. The cup in accordance with claim 7, wherein the floatable member of the floatable strainer has a periphery formed with a plurality of protruding spacers which are equally spaced from each other to separate the narrow gap from the floatable member equally.

9. The cup in accordance with claim 7, wherein the floatable member of the floatable strainer has an inside formed with an air chamber that is connected to an upper portion of the receiving chamber of the cup body and the strainer body through the narrow gap.

10. The cup in accordance with claim 9, wherein the floatable member of the floatable strainer is received in a lower portion of the receiving chamber of the cup body.

11. The cup in accordance with claim 9, wherein the air chamber of the floatable member is open in a direction opposite to that of the receiving chamber of the cup body and the receiving space of the strainer body.

12. The cup in accordance with claim 2, wherein:
the cup body has an open upper end formed with a recessed mounting seat;
the movable handle includes a fixing member secured on the mounting seat of the cup body and a handle body movably mounted on the fixing member and movable into the receiving chamber of the cup body.

13. The cup in accordance with claim 12, wherein the floatable strainer has a height smaller than that of the mounting seat of the cup body.

14. The cup in accordance with claim 12, wherein the handle body of the movable handle has an upper portion provided with a horizontal slide slidably mounted on the fixing member to guide movement of the handle body relative to the fixing member.

15. The cup in accordance with claim 12, wherein the handle body of the movable handle has a substantially inverted L-shaped profile.

16. The cup in accordance with claim 12, wherein:
the handle body of the movable handle is movable toward the cup body to extend the slide into the receiving chamber of the cup body to rest on an end of the floatable strainer to stop movement of the floatable strainer;
the handle body of the movable handle is movable outwardly relative to the cup body to space the slide from the cup body.

17. The cup in accordance with claim 2, further comprising a movable control valve mounted on a bottom of the cup body and connected to the receiving chamber of the cup body and the air chamber of the floatable member.

18. The cup in accordance with claim 17, wherein the bottom of the cup body has a peripheral wall formed with an annular skirt extending downward to encompass the control valve which is fully hidden in the skirt.

19. The cup in accordance with claim 3, wherein the floatable member of the floatable strainer has a size greater than that of the strainer body.

20. The cup in accordance with claim 1, further comprising a lid removably mounted on the cup body or the floatable strainer.
